(19) United States
(12) Patent Application Publication
(10) Pub. No.: US 2016/0115058 A1
(43) Pub. Date: Apr. 28, 2016

(54) CONTROL APPARATUS AND METHOD FOR A SEWAGE PLANT

(71) Applicant: Siemens Aktiengesellschaft, Muenchen (DE)

(72) Inventors: Daniel LABISCH, Karlsruhe (DE); Bernd-Markus PFEIFFER, Woerth (DE); Andreas PIRSING, Sommerfeld (DE)

(73) Assignee: SIEMENS AKTIENGESELLSCHAFT

(21) Appl. No.: 14/920,478

(22) Filed: Oct. 22, 2015

(30) Foreign Application Priority Data
Oct. 23, 2014 (EP) 14190126

(51) Int. Cl. C02F 3/30

(52) U.S. Cl. CPC C02F 3/302; C02F 2209/001; C02F 2101/16

(57) ABSTRACT

Control apparatus and method for a sewage plant in which wastewater is nitrified and denitrified in an aeration tank by intermittent ventilation via a controllable ventilation facility, where the ammonium content of the wastewater is measured and the nitrification phase is terminated by switching off the ventilation if the measured ammonium content has dropped below a threshold value, where in order to improve control of the nitrification, the output of the ventilation facility is controlled within the duration between the start and the end of the nitrification phase as a function of the currently measured ammonium content of the wastewater and the threshold value.

### BACKGROUND OF THE INVENTION

1. Field of the Invention

The invention relates to a method and control apparatus in which wastewater is nitrified and denitrified by intermittent ventilation in an aeration tank via a controllable ventilation facility having a probe for measuring the aluminum content of the wastewater.

2. Description of the Related Art

With biological wastewater treatment in accordance with the activated sludge method, wastewater is freed of aerobic microorganisms, the so-called activated sludge, of organic impurities via metabolism activity. Here, the breakdown of nitrogen occur by nitrification and denitrification. During nitrification, aerobic conditions must prevail, so that ammonium (NH4) can be oxidized in nitrate (NO3) by autotrophic microorganisms. During the subsequent denitrification, the nitrate is converted into nitrogen (N2). To this end, anoxic conditions must exist so that heterotrophic microorganisms use the nitrate oxygen to breathe and are able to perform the conversion into nitrogen.

In order to be able to perform the nitrification and denitrification in just one aeration tank, the tank is alternately (intermittently) ventilated and not ventilated. With pressurized air ventilation, the output of the ventilation is regulated by on/off switching and the speed is regulated by fans or compressors, where the compressed air is introduced into the tank via controllable vent flaps if a number of tanks are supplied by a compressor.

With modern automation concepts, the switchover between nitrification and denitrification occurs as a function of the ammonium and nitrate content, which is measured with the aid of an NH4/NO3 combined probe (see US 2012/006414 A1, US 2014/263041 A1, U.S. Pat. No. 7,416,669 B1). The nitrification phase and thus the ventilation are terminated as soon as sufficient ammonium has been broken down, i.e., the concentration of ammonium nitrogen (NH4—N) has dropped to below a threshold value of, e.g., 0.5 mg/l. The denitrification phase is terminated as soon as sufficient nitrate has been broken down, i.e., the concentration of nitrate nitrogen (NO3—N) has dropped to below a threshold value of e.g., 8 mg/l.

It is also known to regulate the output of the ventilation during the nitrification phase, where the concentration of the dissolved oxygen is measured in the aeration tank and as constant an oxygen concentration as possible of e.g., 1 to 2 mg/l is ensured via a proportional-integral-derivative (PID) controller. The control action either occur by way of the fan speed or the position of the vent flaps, if a number of tanks are supplied by a fan (see US 2014/0263041 A1).

Fluctuations in the intake with respect to the quantity and/or the concentration of the polluting load, which are caused for instance by adverse weather or behavior patterns of the connected loads (domestic and industrial), represent a significant challenge to operators of sewage plants, because the legal limit values for the workflow of the sewage works in flowing waters have to be met in any circumstance. Current automation concepts can then react as early as possible to changed intake conditions if the concentrations in the aeration tank have changed. In most instances there is, however, no automated response.

A further problem is the difficulty in setting the oxygen control during intermittent operation, because in practice the temporal duration of a nitrification phase is often insufficient to enable a clean settlement of the oxygen regulation.

### SUMMARY OF THE INVENTION

In view of the foregoing, it is an object of the invention to improve the control of the nitrification in a sewage plant.

This and other objects and advantages are achieved in accordance with the invention providing by providing a control apparatus or control method in which, during the nitrification phase, the oxygen concentration only represents an auxiliary control variable to provide suitable ambient conditions for the aerobic metabolism of microorganisms. An oxygen concentration that is constant over a longer time cannot be achieved easily and in terms of technology and biology is also not necessary.

In accordance with the invention, control of the output of the ventilation in the nitrification phase, i.e., the control of the fan speed or the position of the vent flaps, focuses directly on the process variable of primary interest, i.e., on the ammonium concentration. The use of a suitable probe, e.g., NH4/NO3 combined probe, is already provided for detection of the switchover conditions during intermittent operation. As a result, the ammonium measured value is already available. While during conventional control of the ventilation as much air is blown in as is required to achieve the oxygen target value, namely independently of whether so much oxygen is required to break down the polluting load, by adjusting the control concept to ammonium as the main control variable, only as much air is blown in as is actually required to provide the microorganisms with sufficient oxygen for the desired breakdown of the ammonium. The energy consumption of fans increases with the cube of the speed. Consequently, significant energy can be saved via the method and control apparatus of the invention.

The controller is preferably realized as a model-predictive controller, which offers the following advantages or development possibilities for the invention:
slight adjustment to difficult control path dynamics with long dwell times or even dead times by automatically identifying a process model from learning data and using the predicted process behavior during operation,
low-cost realization of target value trajectories as situation-adjusted time curves with the aid of an integrated reference variable filter, and
low-cost, completely tool-assisted realization of a model based dynamic disturbance variable compensation.

The control thus preferably takes place along a predetermined target value curve for the ammonium content of the wastewater, where the target value curve falls below a predetermined threshold value at a predetermined time for the end of the nitrification phase. The ammonium concentration is therefore to drop from a measured start value at the beginning of the nitrification phase to a predetermined target value in a predetermined time. If this is successful, the air quantity blown in is sufficient.

The desired temporal curve of the waste of the ammonium concentration can be predetermined via a reference variable filter, which is advantageously integrated into the model-based predictive controller. The controller operates internally with future target value curves, which are compared with the predicted movements of the control variables. Without the reference variable filter, it is assumed that the current target value is also valid in the future unchanged within the prediction horizon. With a target value jump, this means that the new target value is also already requested in the near future in full, although the process cannot achieve this at all. With the reference variable filter or target value filter, an asymptotic target value trajectory is calculated from the current actual value to the required target value, so that the required target value is reached in the specified time. In this case, the target value is placed just below the threshold value for the switchover in order to terminate the nitrification phase, so that it is ensured that the threshold value is reliably not met and the switchover to denitrification occurs. Significant energy can be saved particularly at the start of the nitrification by the fan being gently started in accordance with the trajectory.

Moreover, a disturbance variable compensation of the supply volume is preferably realized in the aeration tank in order to be able to respond promptly to fluctuations. The disturbance variable compensation can be realized directly with the model-based predictive controller without additional modules, by the influences on account of intake fluctuations being used to correct the predicted time curves.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference is made below to the figures in the drawing, in which:

FIG. 1 shows an example of a sewage plant with a control apparatus for ventilation control,

FIG. 2 shows an example of the inventive control apparatus in accordance with the invention;

FIG. 3 shows graphical plots of results of a simulation of the control method in accordance with the invention;

FIG. 4 show graphical plots of the results of simulation with a conventional controller for comparison purposes; and

FIG. 5 is flowchart of the method in accordance with the invention.

### DETAILED DESCRIPTION OF THE EXEMPLARY EMBODIMENTS

FIG. 1 shows, in a very simplified schematic representation, a sewage plant with an aeration tank 1, which receives wastewater that originates from a sand trap via an intake 2 and has to be cleaned. The wastewater in the aeration tank 1 is biologically cleaned by intermittent nitrification and denitrification. The muddy water mixture reaches a clarifier 4 via an outlet 3, where the activated sludge is separated from the cleaned wastewater and is fed back into the aeration tank 1 as return sludge.

During the nitrification phases, the mixture of wastewater and activated sludge contained in the aeration tank 1 is pressure ventilated via a ventilation facility 5. The ventilation facility 5 can have one or a number of fans 6 or compressors, depending on requirements, which can be switched on and off and, at least in the case of the fan, can be controlled with respect to their speed. If air is supplied into the aeration tank 1 via vent flaps, these can also be controlled.

The ammonium and nitrate content of the sludge water mixture is measured in the aeration tank 1 with the aid of a suitable probe 7, e.g., a NH4/NO3 combined probe. By means of further probes 8, further parameters, such as the dissolved oxygen content, the redox potential or the pH value, can be measured. The nitrification phase and thus the ventilation are terminated as soon as the concentration of ammonium nitrogen has dropped to below a threshold value 9 of, e.g., 0.5 mg/l. During the nitrification, as explained in more detail below, the fan speed or the fan vent position is controlled as a function of the measured concentration of ammonium nitrogen by a controller 10. The denitrification phase following the nitrification phase is terminated as soon as the concentration of nitrate-nitrogen has dropped to below a threshold value of, e.g., 8 mg/l.

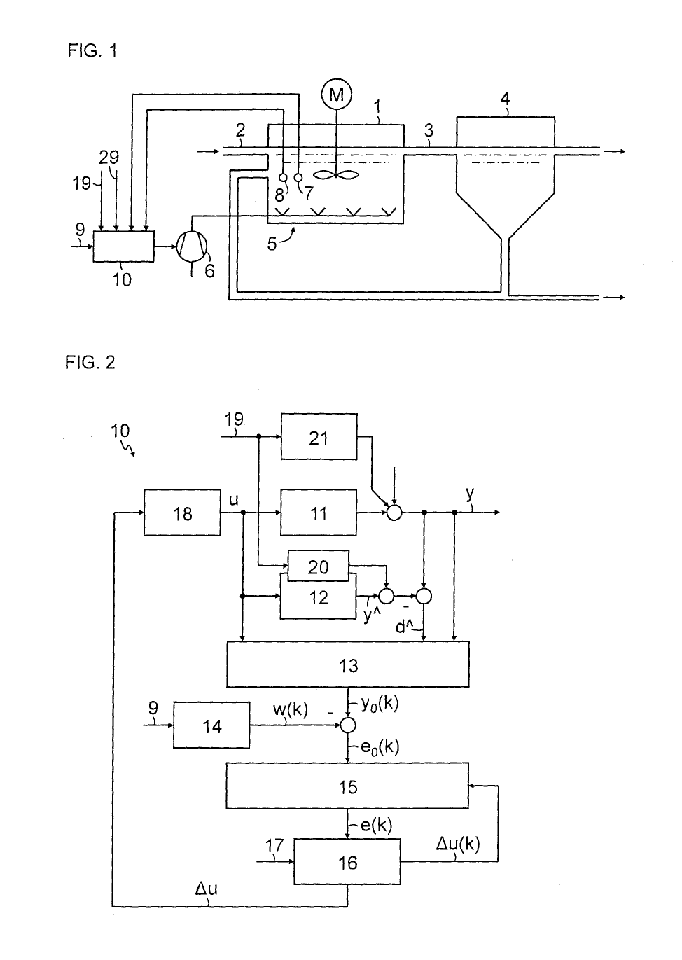

FIG. 2 shows, similarly in a very simplified schematic representation, an example of the controller 10 in the form of a model-based predictive controller (predictive controller). A plant model 12 is connected to the control path 11, i.e., the sewage plant or the process running therein. The speed of the fan 6 (and if necessary further control variables) fed to the control path 11 and the plant model 12 as control variable u, the ammonium concentration acquired with the probe 7 as a main control variable y (and if necessary further measured values such as oxygen content, redox potential, pH value, temperature) and the difference d̂ between the measured control variables y and the control variables ŷ estimated by the model 12 are fed to a first predictor 13, which calculates a prediction y0(k) for the future course of the ammonium concentration. A reference variable or target value filter 14 receives the threshold value 9, where if this is not reached, the nitrification or ventilation phase is to be terminated and calculates a desired temporal curve w(k) of the drop in the ammonium concentration during the nitrification phase in the form of an asymptotic target value trajectory (first order) from the current actual value y of the ammonium content to the required target value. Here, the target value with, e.g., 0.4 mg/l is placed just below the threshold value 9 to ensure that the target value 9 of 0.5 mg/l is not only reached at the end of the nitrification phase but is undershot and the switchover to the denitrification phase occurs. For instance, the threshold value 9 of 0.5 mg/l should be reached in 100 minutes. A second predictor 15 now calculates a curve of the future control deviations e(k) from the deviation e0(k) between the target curve w(k) and the predicted curve y0(k) of the ammonium concentration without control action and the planned future control variable changes Δu(k). On the basis of the future control deviations e(k) and on the basis of optimization and auxiliary conditions 17, an optimizer 16 determines future required curves of control variable changes Δu(k), of which the respective current control variable change Δu is supplied to an integrator 18 to generate the absolute control variable u.

In order to be able to respond proactively to fluctuations in the supply volume of wastewater, a disturbance variable compensation of the supply volume 19 measured in the intake 2 is provided. To this end, the effect of fluctuations in the supply volume 19 on the ammonium concentration is estimated in a computing unit 20 with the aid of historical measurement data with the aid of process identification methods. The disturbance variable compensation can therefore be realized directly in the predictive controller 10 without any additional modules, by the influences from the intake fluctuations being used to correct the predicted variations in time. Functional block 21 clarifies the disturbance effect of the supply volume 19 on the ammonium concentration in the aeration tank 1.

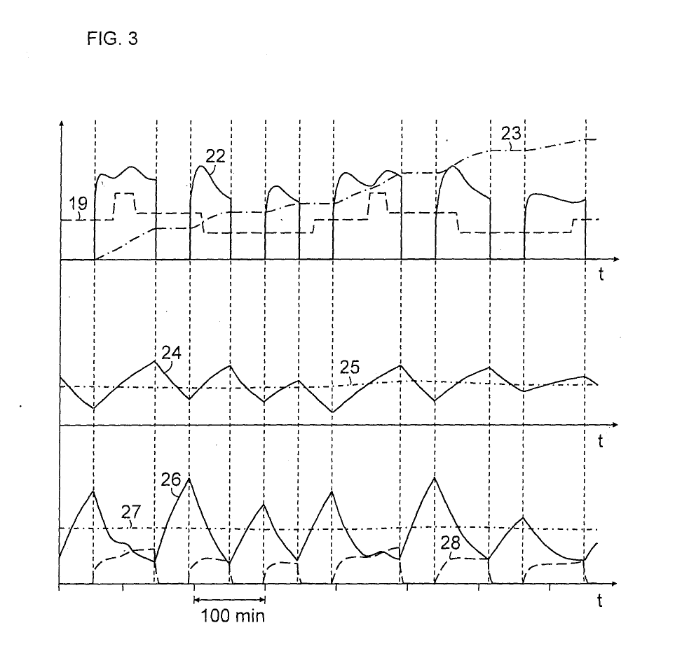

As a result of a simulation from top down, FIG. 3 shows the intake 19, the fan speed 22, the electrical energy consumption 23, the nitrate content 24 in the aeration tank 1, the nitrate content 25 in the clarifier 4, the ammonium content 26 in the aeration tank 1, the ammonium content 27 in the clarifier 4, and the oxygen concentration 28 in the aeration tank 1 during the inventive control of the output of the ventilation according to the ammonium content.

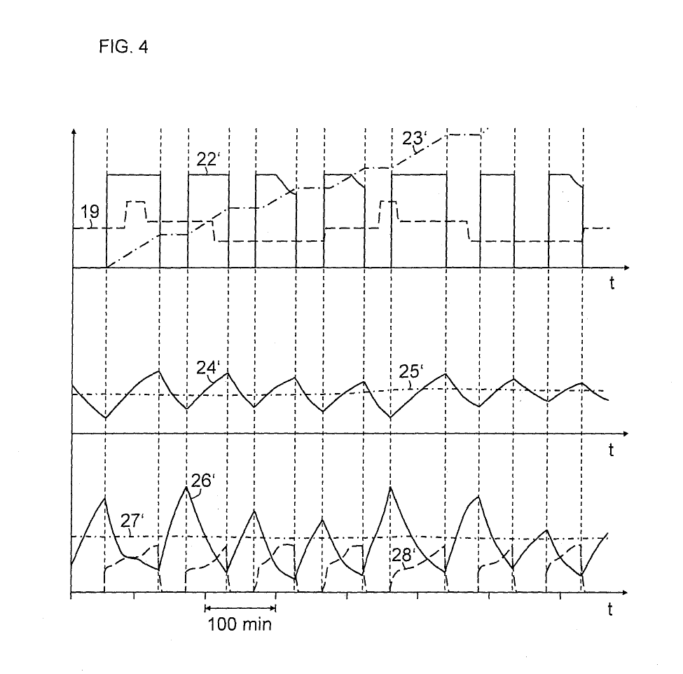

For comparison purposes, FIG. 4 shows in the same intake 19, the fan speed 22′, the electrical energy consumption 23′, the nitrate content 24′ in the aeration tank 1, the nitrate content 25′ in the clarifier 4, the ammonium content 26′ in the aeration tank 1, the ammonium content 27′ in the clarifier 4, and the oxygen concentration 28′ in the aeration tank 1 with a known control of the output of the ventilation according to the oxygen content.

In comparison with the known control (in the simulation), the controller in accordance with the invention can achieve significant energy savings (10 to 40%), particularly at times of low or highly fluctuating supply volumes. Here, the cleaning capacity of the sewage plant is unchanged, because the ammonium and nitrate concentration following purification is the same in both variants. The direct response of the controller in accordance with the invention to supply fluctuations is also clearly visible.

Further sensors can be integrated into the intake 2 (FIG. 1) to the aeration tank 1 for concentration measurements. The concentration measured values obtained can be used as further variables 29 for the disturbance variable compensation. This is particularly relevant in wastewater sewage systems, in which local fluctuations in the dirt load in the drainage area are to a large extent not leveled by mixing in the sewage system, before they reach the sewage plant.

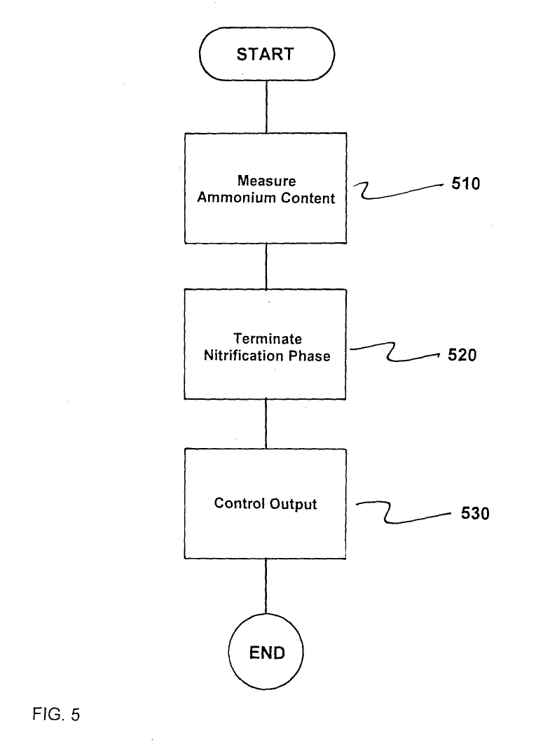

FIG. 5 is a flowchart of a control method for a sewage plant, in which wastewater is nitrified and denitrified in an aeration tank by means of intermittent ventilation by way of a controllable ventilation facility. The method comprises measuring content of ammonium of the wastewater, as indicated in step 510. The nitrification phase is terminated by switching off ventilation if the measured content of ammonium of the wastewater has dropped below a threshold value, as indicated in step 520. An output of the ventilation facility is now controlled as a function of the measured content of ammonium of the wastewater and the threshold value within a duration between a start and end of the nitrification phase, as indicated in step 530.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A control apparatus for a sewage plant, comprising:
a controllable ventilation facility having a probe for measuring the ammonium content of wastewater;
an aeration tank in which wastewater is nitrified and denitrified by intermittent ventilation in the aeration tank via the controllable ventilation facility, the control apparatus being configured to terminate the nitrification phase by switching off the ventilation if the measured ammonium content falls below a threshold value;
a controller configured to generate a control variable in a duration between a start and end of the nitrification phase as a function of a currently measured ammonium content of the wastewater and the threshold value via which the output of the ventilation facility is to be controlled.

2. The control apparatus as claimed in claim 1, wherein the controller is configured as a model-predictive controller with a plant model of the sewage plant and a predictor to calculate a prediction for a future course of the ammonium content without control action as a function of a currently generated control variable and a currently measured ammonium content of the wastewater and to perform a control action comprising a control variable change for the ammonium content as a function of the predicted course and a target value curve.

3. The control apparatus as claimed in claim 2, wherein the controller has a target value filter which calculates a target value curve for the ammonium content of the wastewater, and wherein the target value curve drops below the predetermined threshold value at a predetermined time for an end of the nitrification phase.

4. The control apparatus as claimed in claim 2, wherein the controller includes a further predictor and an optimizer to determine future control variable changes from a deviation between a target curve of the ammonium content and its predicted curve without control action, a respective current control variable change being used for a current control action.

5. The control apparatus as claimed in claim 3, wherein the controller includes a further predictor and an optimizer to determine future control variable changes from a deviation between the target curve of the ammonium content and its predicted curve without control action, a respective current control variable change being used for a current control action.

6. The control apparatus as claimed in claim 1, wherein a supply volume of the wastewater into the aeration tank is applied to the controller as a disturbance variable.

7. A control method for a sewage plant, in which wastewater is nitrified and denitrified in an aeration tank by means of intermittent ventilation by way of a controllable ventilation facility, the method comprising:
measuring content of ammonium in the wastewater;
terminating a nitrification phase by switching off ventilation if the measured content of ammonium of the wastewater has dropped below a threshold value; and
controlling an output of the ventilation facility as a function of the measured content of ammonium of the wastewater and the threshold value within a duration between a start and end of the nitrification phase.

8. The control method as claimed in claim 7, wherein the controller is configured as a model-predictive controller, the method further comprising:
calculating, as a function of a currently generated control variable for controlling the output of the ventilation facility and the currently measured ammonium content of the wastewater, a prediction for a future curve of the ammonium content without control action and as a function of this predicted curve and a target value curve for the ammonium content; and
performing a control action comprising a control variable change.

9. The control method as claimed in claim 7, wherein the control occurs along a predetermined target value curve for the ammonium content of the wastewater, and wherein a target value curve drops below a predetermined threshold value at a predetermined time for an end of the nitrification phase.

10. The control method as claimed in claim 8, wherein the control occurs along a predetermined target value curve for the ammonium content of the wastewater, and wherein the target value curve drops below a predetermined threshold value at a predetermined time for an end of the nitrification phase.

11. The control method as claimed in claim 7, wherein a supply volume of the wastewater into the aeration tank is applied to the controller as a disturbance variable.

12. The control method as claimed in claim 8, wherein a supply volume of the wastewater into the aeration tank is applied to the controller as a disturbance variable.

13. The control method as claimed in claim 9, wherein a supply volume of the wastewater into the aeration tank is applied to the controller as a disturbance variable.
